(19) United States
(12) Patent Application Publication
(10) Pub. No.: US 2007/0046437 A1
(43) Pub. Date: Mar. 1, 2007

(54) Electronic Transmission Device for Activation of Electronic Article Surveillance Systems

(76) Inventors: Mark Pempsell, Bedford, TX (US); Ryan Corley, Austin, TX (US)

Correspondence Address: BAKER BOTTS L.L.P., 2001 ROSS AVENUE, SUITE 600, DALLAS, TX, 75201-2980, US

(21) Appl. No.: 11/466,307

(22) Filed: Aug. 22, 2006

Related U.S. Application Data
(60) Provisional application No. 60/712,533, filed on Aug. 29, 2005.

(51) Int. Cl. G08C 19/06; H04Q 5/22

(52) U.S. Cl. 340/10.34; 340/870.31; 340/572.1; 340/10.1; 340/572.3; 340/10.5

(57) ABSTRACT

In accordance with the teachings of the present invention, an electronic transmission device for the activation of electronic article surveillance systems is provided. In a particular embodiment, an electronic frequency transmitter includes an electronic transmitter producing a frequency of 58 KHz synchronized at the proper level and repetition rate, a receiving coil to convert electro-magnetic pulses to DC current, a transmitter antenna, and a deactivation circuit.

### RELATED APPLICATION

This application claims the benefit of U.S. Provisional Application Ser. No. 60/712,533 filed Aug. 29, 2005.

### TECHNICAL FIELD OF THE INVENTION

The present invention relates generally to article surveillance systems and, in particular, to an acousto-electronic article surveillance system.

### BACKGROUND OF THE INVENTION

the problem of protection of articles of merchandise and the like against theft from retail stores has been the subject of numerous technical solutions. Among these, a tag or marker is secured to an article to be protected. The tag responds to an interrogation signal from a transmitting apparatus situated either at the exit door of the premises to be protected, or at the aisle-way adjacent to the cashier or check out station. A receiving coil on the opposite side of the exit or aisle-way from the transmitting apparatus receives a signal produced by the tag in response to the interrogation signal. The presence of the response signal indicates that the tag has not been removed or deactivated by the cashier and that the article bearing it may not have been paid for or properly check out.

Several different types of tags have been disclosed in literature and are in use. The acousto-magnetic type of marker consists of a first elongated element of high magnetic permeability ferromagnetic material disposed adjacent to at least a second element of electromagnetic material having higher coercively than the first element. When subjected to the interrogation frequency of electromagnetic radiation, the tag causes harmonics of the interrogation frequency to be developed in the receiving coil.

Electronic article security systems of the type discussed above have been shown to be very effective in preventing the theft or unauthorized removal of articles, particularly articles which are small in size and relatively expensive.

### SUMMARY OF THE INVENTION

The present invention relates to a security tag representative in output frequency characteristics in regards to the mechanical acousto magnetic tag device, This invention utilizes the latest in micro-electronic technology readily available to those skilled in the art to practice the invention. Therefore, the present invention is specifically designed to introduce electronic article surveillance (“EAS”) protection tag that in its present form will, when positioned within proximity of the interrogation, gates transmit a signal at the same frequency as the readily available mechanical acousto-magnetic security tags.

This invention utilizes four major components. The first of four is a receiving antenna used to gather electro-magnetic energy transmitted from the EAS interrogation gates located at the exits of retail outlets. This antenna when energized externally, win gather transmitted energy thereby converting said energy in a form suitable to power a micro electronic circuit. The second article of the invention consists of an electronic micro transmission tuned to emit a 58 KHz or a “tower-centric” signal as encouraged by the Consumer Product Manufacturers Association at an amplitude sufficient to trigger an existing EAS interrogation gate. The third component of the invention is an antenna sufficient in property to transmit the activation signal to the impending interrogation field. The final portion of the preferred embodiment is a means to deactivate the interrogation field thus by disabling the unit from transmitting said signal.

The procedure of utilizing micro electronic circuitry will enable the AM tag system to be miniaturized and thereby providing a unique and inconspicuous means of item identification to reduce theft of wholesale and retail merchandise.

Other technical advantages of the present invention may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and features and advantages thereof, reference is now made to the following description, taken in conjunction with the accompanying drawings, in which:

FIG. 1 illustrates an electronic article surveillance tag in accordance with a particular embodiment of the present invention; and

FIG. 2 illustrates an interrogation gate in accordance with a particular embodiment of the present invention.

### DETAILED DESCRIPTION OF THE INVENTION

In the following detailed description of the preferred embodiments, reference is made to the accompanying drawing which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical, electrical and structural changes may be made without departing from the spirit or scope of the invention. To avoid detail not necessary to enable those skilled in the art to practice the invention, the description may omit certain information known to those skilled in the art. The following detailed description is therefore, not to be taken in a limited sense and the scope of the present invention is defined only by the appended claims.

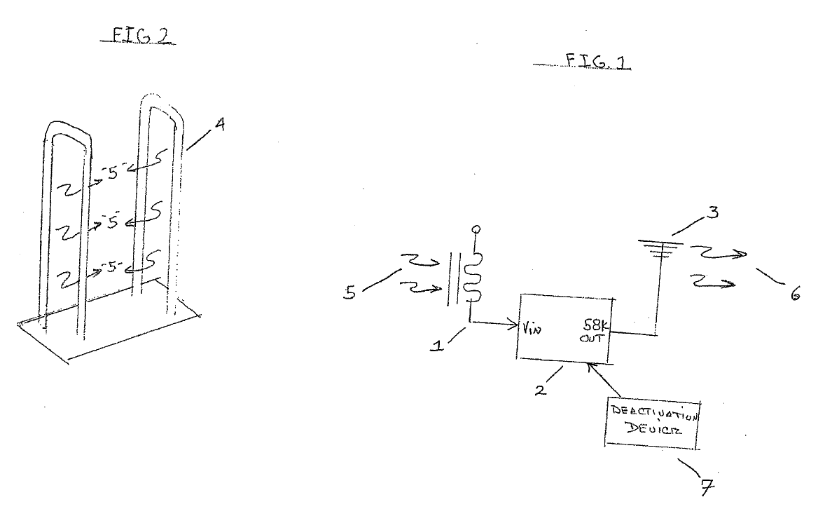

Referring to FIGS. 1 and 2, wherein the same reference numeral designations are applied to corresponding components or functionality throughout the figures, an interrogation gate transmitting an electromechanically magnetic pulse 5 according to the present invention is illustrated. An EAS tag 2 is comprised of an electronic micro circuit which when energized will transmit an alternating 58 KHz or equivalent signal of sufficient amplitude and signal strength to trigger the EAS interrogation gate 4. The EAS interrogation gate 4 transmits an electrical signal 5 and at the same time listens electronically for a matching signal 6. When the interrogation gate 4 receives a signal 6 of the same frequency, the alarm will sound. The EAS tag 2 in FIG. 1 consists of a receiving coil 1 which when introduced to the proximity of the interrogation gate 4 and its transmission frequency 5 will energize the coil 1 thus by supply ample electricity to power the EAS tag 2. When the EAS tag 2 is energized it will transmit a signal 6 from the external antenna 3. The transmitted signal 6 can then be detected by the EAS interrogation gate 4 and the alarm will sound. When an item is properly obtained, the EAS tag 2 can be deactivated by means located at most cashier lines. The deactivation device 7 works in conjunction with the electronic EAS tag 2.

Electronic article surveillance system technology is used to identify articles as they pass through a gated area in a store. This identification is used to alert someone that unauthorized removal items are being attempted. EAS systems are useful anywhere there is an opportunity for theft of items of any size. EAS technologies are being produced to reduce shoplifting, help increase sales, lower labor costs, speed inventory, improve stockroom logistics and increase security.

Three types of EAS systems dominate the retail industry. In reference to the embodiment of this application, this invention is specific to the acousto-magnetic EAS tag. These tags or labels are attached to an item. The tag is then deactivated, or taken from an active state where it will alarm an EAS system to an inactive state where it will not flag the alarm. If the tag is a hard, reusable tag, a detacher is used to remove it when a customer purchases an item to which the tag is attached. If it is disposable, it can be deactivated by swiping it over a pad or with a hand held scanner that “tells” the tag that it has been authorized to leave the store. If the item has not been deactivated, when it is carried through the gate, an alarm will sound.

An acousto-magnetic (AM) system, which allows for high speed label application, uses a transmitter to create a surveillance area where tags are detected. The transmitter sends a radio frequency signal (58 KHz) in pulses, which will energize the tag in the surveillance zone. When the pulse ends, the tag responds by emitting a single frequency signal. While the transmitter is off between pulses, the AM tag signal is detected by the receiver. A microcomputer checks the AM tag signal detected by the receiver to ensure it's at the right frequency, is time synchronizes to the transmitter, at the proper level and the correct repetition rate. If all criteria are met, the alarm will activate.

Although particular embodiments of the method and apparatus of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. An electronic frequency transmitter comprising:
an electronic transmitter producing a frequency of 58 KHz synchronized at the proper level and repetition rate;
a receiving coil to convert electro-magnetic pulses to DC current;
a transmitter antenna; and
a deactivation circuit.
